(19) United States
(12) Patent Application Publication
(10) Pub. No.: US 2007/0006126 A1
(43) Pub. Date: Jan. 4, 2007

(54) On-line computer aided design project tracking system

(76) Inventors: Timothy D. Calkins, Ortonville, MI (US); Mark J. Hochstein, Troy, MI (US)

Correspondence Address: Steven W. Hays, Suite 250, 28333 Telegraph Road, Southfield, MI, 48034, US

(21) Appl. No.: 11/414,802

(22) Filed: May 1, 2006

Related U.S. Application Data
(60) Provisional application No. 60/676,236, filed on Apr. 29, 2005.

(51) Int. Cl. G06F 9/44

(52) U.S. Cl. 717/103; 717/102

(57) ABSTRACT

A web-based project management tool that allows parties collaborating on a program to seamlessly connect with one another, regardless of location and size, to share project information, track program progress and exchange data as needed in a secure environment. The parties assign administrators, team leaders and team members access to a secured website to view, track, manage and release information data for projects, workflows and tasks related to the program on a permission-granted basis. Parties are not required to install and maintain or otherwise utilize heavy software downloads, but are offered a means to establish direct connectivity with each other and others as needed to manage any and all electronically-based projects.

### CROSS REFERENCE TO RELATED APPLICATION

The present invention claims priority from U.S. Provisional Application Ser. No. 60/676,236, filed Apr. 29, 2005, entitled “On-line Computer Aided Design Project Tracking System.”

### TECHNICAL FIELD

The invention relates generally to project tracking systems and more specifically to an on-line project tracking system.

### BACKGROUND ART

Recently, in many industries, with regard to systemization, technology has been developing at an incredible pace. The demand for compliance and security associated with this technological growth has been demanding and costly. Further, are demanding the ability to view, track, and manage data supplied to third-companies party suppliers from their own personal computers (“PC”) or laptops. Presently, many companies do not have the ability internally to be able to interact and share data with third-party suppliers or other individuals and companies, especially when any of these entities are located overseas. Further, many companies do not have the ability to access data from projects subcontracted to lower-tier suppliers by the third-party suppliers.

### SUMMARY OF THE INVENTION

The present invention provides a process for fulfilling these requirements and supplying companies with the ability to view, track, manage and release informational data for programs to and from third-party suppliers and other entities from their own PC or laptop.

The present invention allows companies and various other entities to have access to a secure website, via a secure SSL login ID, provided by a third-party service provider, to track their parts and programs through on-line transmittal requests. The present invention utilizes a secure infrastructure of servers, software, secure data lines, and data management staff to hold and track company files. The present invention provides a resource center for requesting and viewing data transmittal, requesting design work orders, viewing and updating design work orders, viewing time summaries and usage reports, and viewing data. The resource center also provides a means for scheduling net meetings. The resource center also allows for company uploads. Further, the present invention allows for the introduction of accessible on-line programs for training purposes and for the seamless introduction of updated software used in one or more of the applications. Finally, the resource center provides a safe and secure online file management archive.

The resource center can be easily tailored with specific data formats and transfer criteria depending upon the desires of the company utilizing the project tracking system. The software system embedded in the tracking system can be set up with varying data retention periods, data levels, project milestones and project assumptions that are specifically designed for an individual project.

Further, the resource center provides the means for transferring the data via physical mediums such as magnetic tapes or CD-ROMS in addition to or in conjunction with the electronic means described above.

The present invention thus provides a centralized, safe and secure project tracking system accessible by one, some or all parties (manufacturing companies, assemblers, third-party suppliers, lower tier suppliers) via their PC's and laptops. This allows for the parties to simultaneous collaborate and communicate on projects regardless of the remoteness of their locations. This leads potential cost savings in many facets, including costs associated with bringing designs from the conceptual stage to production and costs associated with training and capital improvements. Further, because the third party service provider maintains the tracking system, installation and update costs are borne by the third-party service provider, not the parties utilizing the system. Finally, because the access to the website is limited by the parties themselves to individuals through a permission-based access system, concerns about protection of company assets and other intellectual property are minimized.

Other features, benefits and advantages of the present invention will become apparent from the following description of the invention, when viewed in accordance with the attached drawings and appended claims.

### BRIEF DESCRIPTION OF THE DRAWINGS

FIG. 1 is a schematic flow chart describing the electronic data management model in accordance with a preferred embodiment of the present invention; and

FIG. 2 is a schematic representation of an explorer web page accessible through the electronic data management model of FIG. 1;

FIG. 3 is a schematic representation of a projects web page accessible through the electronic data management model of FIG. 1;

FIG. 4 is a schematic representation of a workflows web page accessible through the electronic data management model of FIG. 1;

FIG. 5 is a schematic representation a task web page accessible through the electronic data management model of FIG. 1;

FIG. 6 is a schematic representation of a time summary report web page accessible through the electronic data management model of FIG. 1;

FIG. 7 is a schematic representation of a timesheet report web page accessible through the electronic data management model of FIG. 1;

FIG. 8 is a schematic representation of a file summaries web page accessible through the electronic data management model of FIG. 1;

FIG. 9 is a schematic representation of a my tasks web page accessible through the electronic data management model of FIG. 1;

FIG. 10 is a schematic representation of a search web page accessible through the electronic data management model of FIG. 1; and

FIG. 11 is a schematic representation a privileges web page accessible through the electronic data management model of FIG. 1.

### BEST MODE(S) FOR CARRYING OUT THE INVENTION

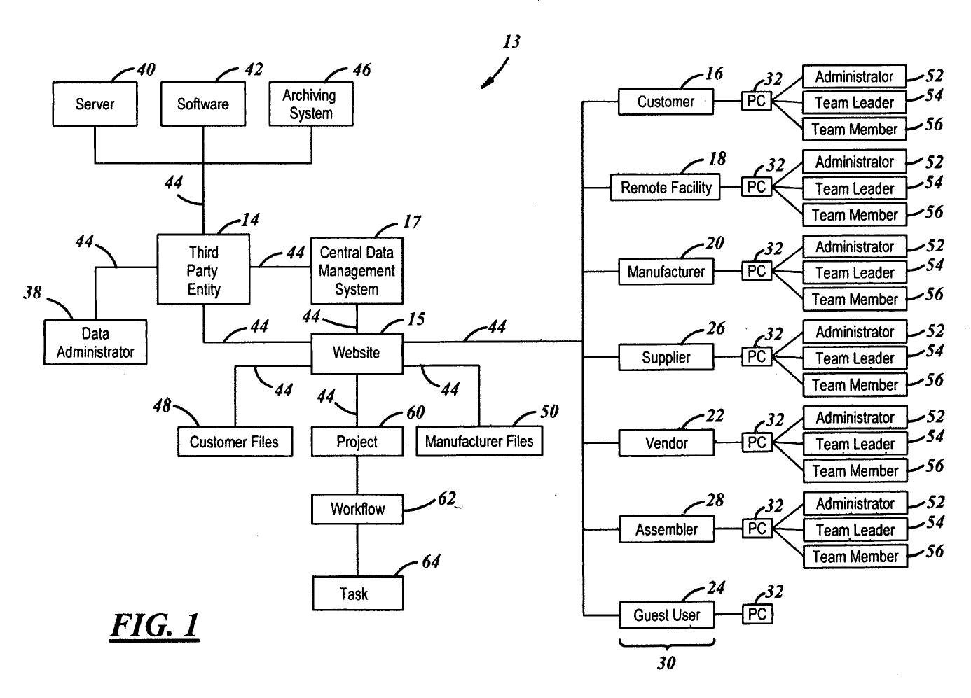

Referring now to FIG. 1, an electronic data project management model 13 is described in conjunction with a preferred embodiment of the present invention as having a central data management system 17 hosted by a third party entity 14, preferably in the form of a secured website 15, that is electronically accessible between a customer 16, either at their home office or other remote facilities 18, a manufacturer 20, one or more of a customer's vendors 22, suppliers (third party or lower tier) 26, assemblers 28, or guest user 24 (collectively known as parties 30). In this system 17, selected individuals (either administrators 52, team leaders 54 or team members 66) of the parties 30 are granted permission to enter the website 15 through a personal computer (“PC”) or laptop 32 to review various projects 60, workflows 62 and tasks 64 that are common among one or more of the parties 30. The individuals are then able to view, track, manage and release data quickly from one or more of the projects 60, workflows 62 and tasks 64 to which they have privileges.

The host entity 14 preferably provides data management staff 38 to monitor the central data management system 17 to provide technical support and acts as a resource for aiding the parties 30 in navigating the various programs and requests.

The host entity. 14 provides infrastructure, in the form of secure servers 40, software 42, data lines 44, and archiving systems 46 linked to the website 15 to hold and track customer's files 48 and manufacturer's files 50 for use in a particular project 60, workflow 62, or task 64. Alternatively, the parties 30 may choose to hold the files 48, 50 outside of the system 13, but allow individuals to view and manage or otherwise track and transmit the files 48, 50 through the system 13. Further, the host entity 14 provides the means for transferring the data via physical mediums such as magnetic tapes or CD-ROMS in addition to or in conjunction with the electronic means described above.

The central data management system 17 is preprogrammed and continuously updated by administrators 52 and/or designated team leaders 54 of one or more of the parties 30 with particular project information, deadlines, milestones and other information relevant to a particular project 60, workflow 62 and task 64. Moreover, the administrators 52 and/or team leaders 54 designate one or more individuals, or team members 66, from one or more of the parties 30 to have access to one or more of the projects 60, workflows 62 and tasks 64.

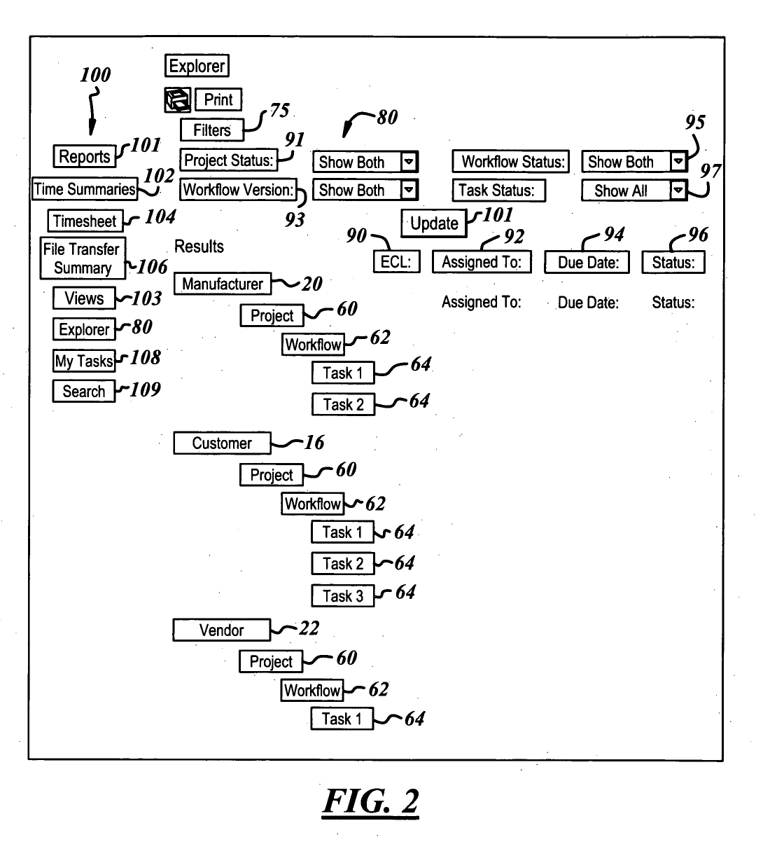

The central data management system 17 is preprogrammed with accessible contact information for the parties 30 that are involved in a program defined by a particular project 60, workflow 62 or task 64. The central data management system 17 is also preprogrammed and constantly updated to provide the latest in computer software and programs necessary to complete a particular project 60, workflow 62 or task 64. The central data management system 17 is also programmed with data formats of various categories and transfer criteria, data retention criteria, project milestones, and project assumptions. FIGS. 2-11 illustrates a detailed representative example disclosing how an administrator 52, team leader 54 or individual team member 66 can access the website 15 and perform or otherwise communicate or collaborate on various projects 60, workflows 62 or tasks 64.

The model 13, as described specifically in FIG. 1 above and FIGS. 2-11 below, is hereinafter descried for use specifically in computer aided design (“CAD”) projects, in which the parties 30 includes customers, suppliers, vendors, manufacturers, assemblers, and other individuals or companies coordinating together to provide CAD drawings and files (two-dimensional and three-dimensional files) for use in producing prototypes or parts or completing other programs for an original equipment manufacturer (“OEM”). Thus, some of the description of the preferred embodiment herein may include subtleties and particular aspects that are specifically related to achieving to producing such parts. However, minor modifications within the spirit of the present invention allows the system 13 as described in FIG. 1-11 to be used on a wide variety of projects in other industries, in which specific parties collaborate to achieve a desired result.

Referring now to FIG. 2, after the administrator 52 or team leader 54 or team member 66 logs into the secured login feature 36, they are directed to an introductory web page 80, otherwise known as the explorer web page 80 that details a complete list of all projects 60, workflows 62, and tasks 64 to which the team member 66 has been previously granted access by an administrator 52 or project manager 54. The explorer web page 80 gives a summary of the details of information regarding each projects 60, workflows 62, and tasks 64, including any change levels (wherein a party can track modifications to a particular aspect or file of a particular project, workflow or task) 90, who a particular project is assigned to 92, due date 94 and status 96 of the particular category (open or closed). The administrators 52, project managers 54 and team leaders may then open, move, edit, change, or otherwise manipulate informational data contained in the files 48, 50 associated with any project 60, workflow 62, or task to which they have privilege, to the extent that their privilege allows. Thus, for example, a team member 66 who has viewing privileges only for a project 60 will only be able to view any files associated with the project 60 and will not be able to manipulate any informational data associated with the project 60, while a second team member who has editing privileges may also edit a portion of the project 60 for which they are granted privilege.

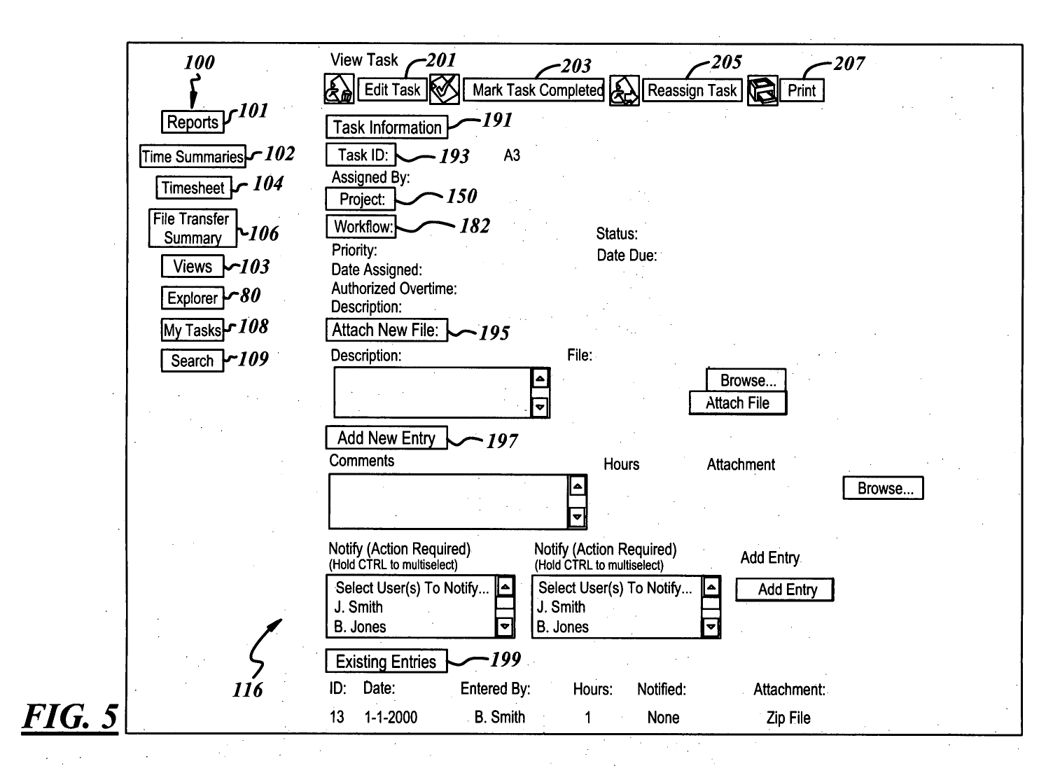

Each of the listed projects 60, workflows 62 and tasks 64 includes an available hyperlink 110 that directs you to another respective web page 112, 114, 116 that details the various features of each of the projects 60, workflows 62 and tasks 64. Each of these web pages 112, 114, 116 will be described in further detail below. Thus, for example, by clicking on “Task 1” icon 64 as shown in FIG. 2, a team member 66 having privileges to the tasks 64 in this task flow, associated with a specific workflow 62 and project 60, would be directed to task web page 116 shown below in FIG. 5 that is specifically designed to display details that the team member 66 is assigned to complete.

In addition, the explorer web page 80 provides a set of filters 75 that allows the administrator 52 or team leader 54 or team member 66 to display the web page based on a wide variety of attributes. Thus the web page 80 can be filtered and viewed for project status 91 (open, closed, or both), workflow versions 93 (latest and outdated versions), workflow status 95 (open, closed, or both), and task status (open, closed, or both) by clicking the update button 101. This allows the administrator 52 or team leader 54 or team member 66 to view one or more projects, or particular workflows or tasks related to projects, or any combination thereof, to provide a clear understanding of what is done, what needs to be done, and who is performing the task, regardless of location, and provide insight as to how things were accomplished.

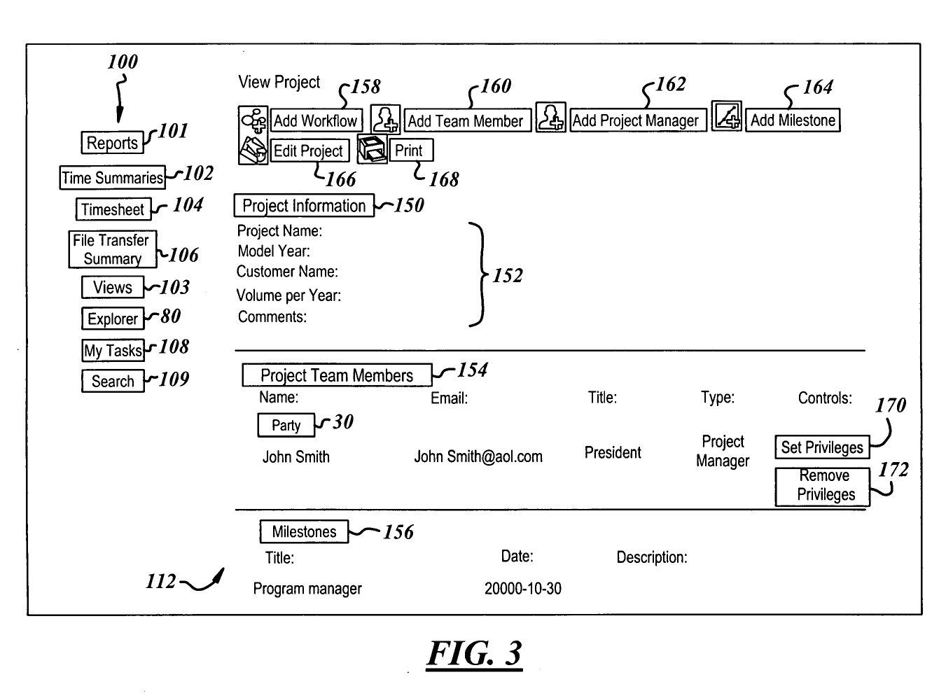

Referring now to FIG. 3, a detailed view of the projects web page 112 is illustrated. The web page 112 lists general details 152 of this particular project 150. For example, in a CAD design project, relevant details that may be displayed include project name, model year, customer name, OEM, any volumes or other comments. The web page 112 also provides information for any project team members 154 previously assigned to the particular project, separated by party. The web page 112 also provides details for any particular milestones 156 for the project 150, such details including titles, dates and description. Moreover, the web page 112 provides links wherein the administrator 52 or team leader 54 or team member 66, depending upon their privilege level, may edit or otherwise add workflows 158, add team members 160, add project managers 162, add milestones 164, edit projects 166 or print 168 summaries of the project.

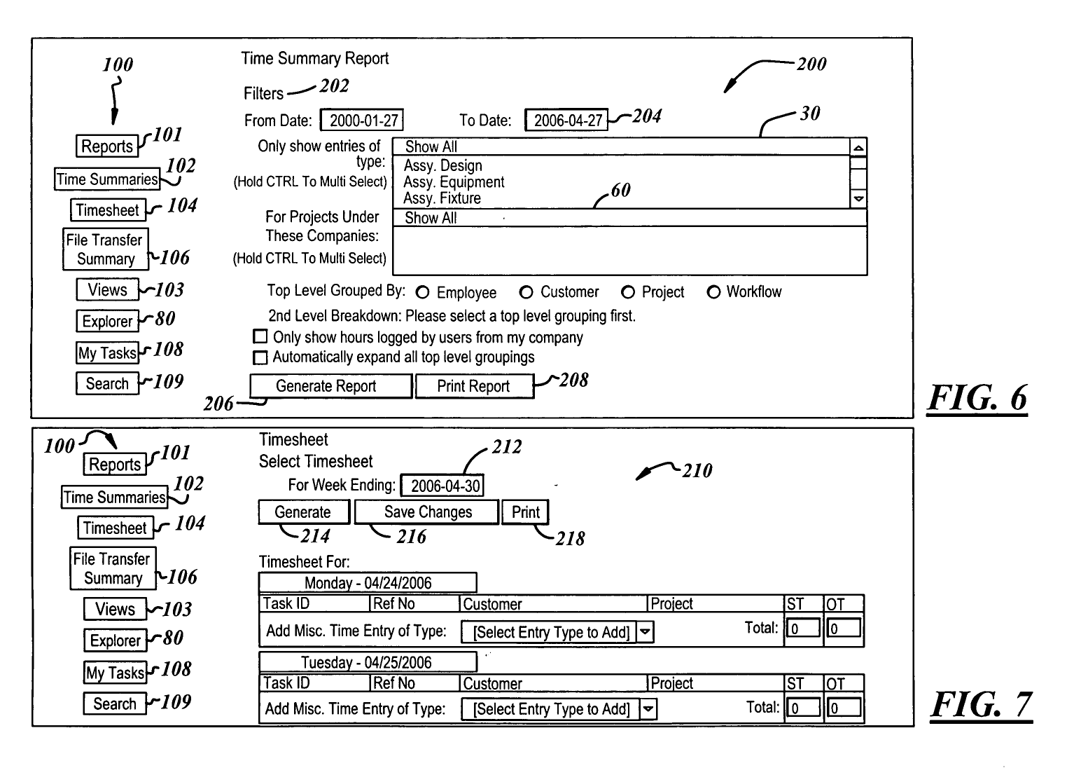

To reach this web page 112 of FIG. 3, the administrator 52 or team leader 54 or team member 66 opens a particular project link 60 from FIG. 2 and is directed to web page 112 that specifies the details of this particular project 150. The web page 112 may also display links allowing the administrator 52 or team leader 54 or team member 66 to set privileges 170 or remove privileges 172 for a particular team member 154, which will be detailed further below in FIG. 6.

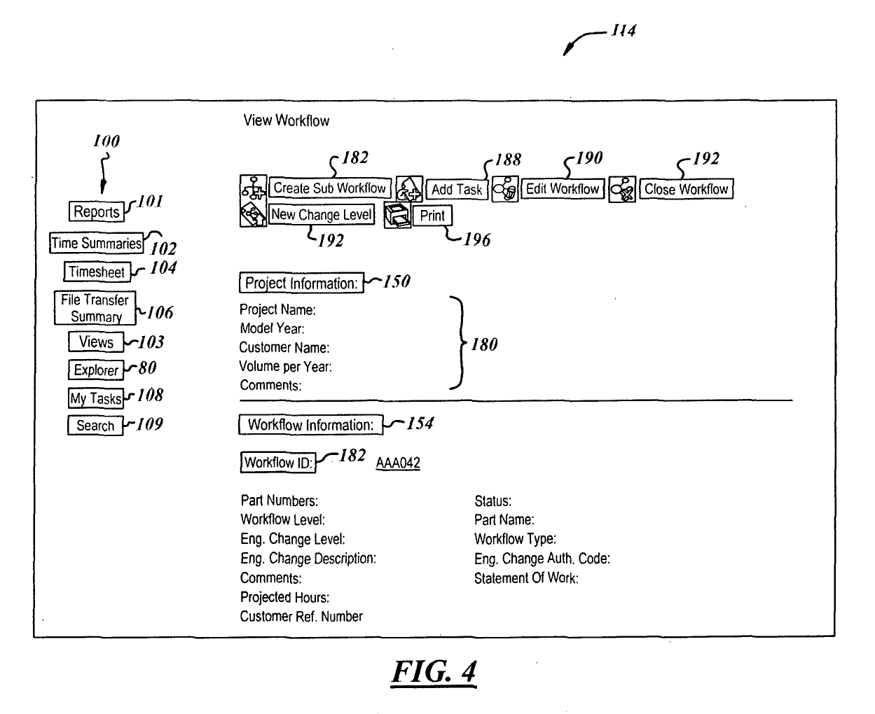

Referring now to FIG. 4, a detailed view of the workflow web page 114 for a particular project 150 is illustrated. To reach this web page 114 of FIG. 4, the administrator 52 or team leader 54 or team member 66 opens a particular workflow link 62 from FIG. 2 and is directed to web page 114 that specifies the details of this particular project 150. The workflow web page 114 lists general details 180 of how the particular aspects of the project will proceed, and is assigned a unique workflow ID 182. For example, as above in FIG. 3, for a CAD design project, relevant details that may be displayed include project name, model year, customer name, OEM, any volumes or other comments.

The workflow web page 114 also provides general details regarding workflow information 184, including but not limited to listing general details about an ongoing or completed project, as well as information relevant to the project, including estimated workflow hours to complete the project and descriptions or comments about necessary activities associated with the workflow. Relevant workflow information, including for CAD design projects, could include part numbers and names, engineering change levels and authorization codes, customer reference numbers, and workflow levels and types.

Similar to the project web page 112, the workflow web page 114 provides links wherein the administrator 52 or team leader 54 or team member 66, depending upon their privilege level, may edit or otherwise create sub workflows 186 associated with the workflow, add tasks 188 associated with the workflow, edit workflows 190, close workflows 192, add new change levels 194 to the workflows, or print 196 summaries of the workflow.

Referring now to FIG. 5, , a detailed view of the task web page 116 for a particular project 150 and workflow ID 182 is illustrated. To reach this web page 116 of FIG. 5, the administrator 52 or team leader 54 or team member 66 opens a particular task link 64 from FIG. 2 and is directed to task web page 116 that specifies the details of this particular project 150 and workflow ID 182. The web page 116 also displays a particular task ID 190 (in the form AB, wherein A is an alphabetic string and where B is a numeric string) which is tied to the particular workflow ID 182 and project 150.

The task web page 116 is organized along similar lines to the project web page 112 and workflow web page 114. The web page 116 includes sections for reviewing task information 191, attaching new files 195 relevant to the particular task, adding new entries 197 relevant to the particular task, and viewing existing entries 199 relevant to the particular task. In this way, the administrator 52 or team leader 54 or team member 66 can review all completed and pending tasks relevant to the particular workflow 182 and project 150 for completeness and status.

The web page 1.16 also provides links wherein the administrator 52 or team leader 54 or team member 66, depending upon their privilege level, may edit tasks 201, mark tasks as completed 203, reassign tasks 205 to different team members 66, and print 207 the currently displayed task information from the web page 116.

The task web page 116 therefore allows the administrator 52 or team leader 54 or team member 66 to view, edit and update relevant tasks necessary for the project. It also allows the administrator 52 or team leader 54 or team member 66 to add or otherwise attach additional information, in the form of files and the like. Moreover, it allows the administrator 52 or team leader 54 or team member 66 to review existing entries 198 to gauge the relative progress of a particular workflow 182 or project 150 and allocate resources accordingly.

Examples of a non exhaustive list of tasks 64 or other information that are preferably included in support of the project 60 include providing program definition, request data transmittal, view data transmittals, request work orders, view or update work orders, view time summaries, view usage reports, view data, customer upload resource, and the ability to schedule net meetings.

These web pages 80, 112, 114, and 116 of FIGS. 2-5, as well as all other web pages available on the website 15, also displays available hyperlinks 100 that are available to the administrator 52 or team leader 54 or team member 66, separated into a reports category 101 and a view category 103. The reports category 101 provides links to a time summaries web page 102, a timesheets web page 104, and a file transfer summaries web page 106, while the views category 103 provides links to the aforementioned explorer web page 80, a my task web page 108, and a search web page 109. Each of these other web pages 102, 104, 106, 108 will also be described further below.

Referring now to FIG. 6, a detailed view of the time summary report web page 200 for a particular project 150 and workflow ID 182 is illustrated. To reach this web page 200, the administrator 52 or team leader 54 or team member 66 opens the time summaries report hyperlink 102 from any available web page. The time summaries web page 200 generates a report for all time entries created for any number of projects 60. The web page 200 contains a filter 202 that allows time entries to be sorted by date 204, by party 30, and/or by project 60. The filter 200 also allows the information to be grouped and displayed in a myriad of different ways. To achieve a particular result, the administrator 52, team leader 54 or team member 66 simply defines the particular criteria and grouping desired and clicks the generate report icon 206 for display on the PC or laptop 32 or clicks the print report icon 208 for review on paper.

As shown in FIG. 7, the timesheet report web page 210 allows an administrator 52, team leader 54 or team member 66 to display any time entries generated for a particular time period for each project 60 to which the individual or party generated a time entry on the task web page 116. To reach this web page 210, the administrator 52 or team leader 54 or team member 66 opens the timesheet report hyperlink 104 from any available web page. The web page 210 has an entry box 212 for manually entering the particular time period for display, and a generate icon 214 for generating a timesheet 220 for the particular week. The web page 210 also allows the timesheets to be saved by clicking the save changes icon 216 and allows the displayed timesheet to be printed by clicking a print icon 218. The timesheet display 220 is displayed to allow the administrator 52, team leader 54 or team member 66 to modify and update particular entries for dates in which a particular entry was entered, as well as information regarding the task ID 190, reference numbers, customer, project and total number of standard time hours and overtime hours.

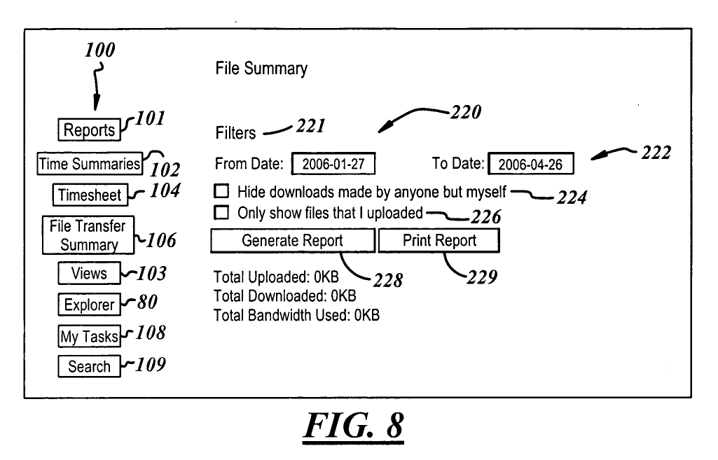

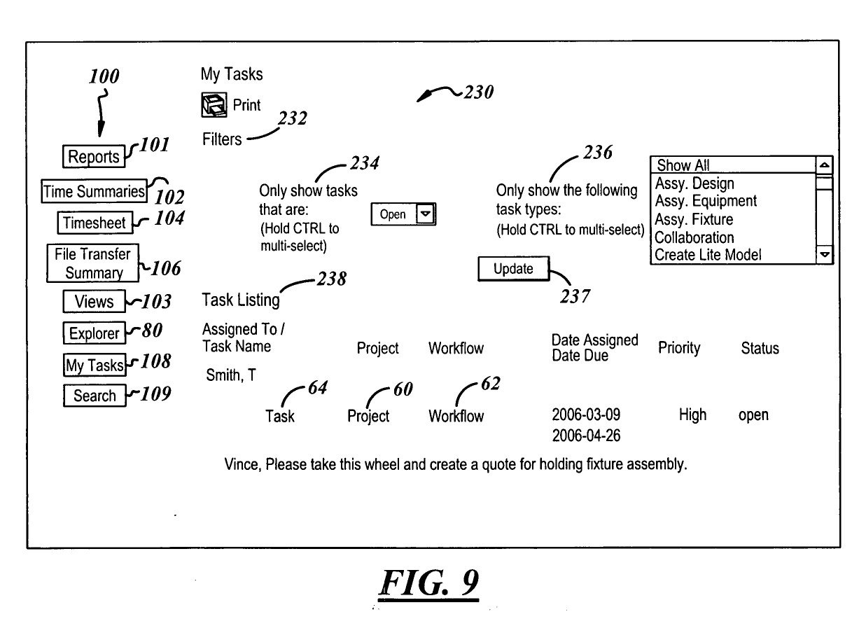

Referring now to FIG. 8, the file summaries web page 220 includes a filtering system 221 through which the administrator 52, team leader 54 or team member 66 can view particular downloaded or uploaded files generated, as well as the amount of storage space required to generate these downloaded and uploaded files. To reach this web page 220, the administrator 52 or team leader 54 or team member 66 opens the file transfer summary hyperlink 106 from any available web page. To review a particular reporting period and particular file transfer data, the administrator 52, team leader 54 or team member 66 enters the relevant time period manually in the date boxes 222, determines which downloads 224 and uploads 226 to review, and clicks the generate icon 228. Moreover, the administrator 52, team leader 54 or team member 66 can print any generated report by clicking the print report icon 229.

Referring now to FIG. 9, the my tasks web page 230 includes a filtering system 232 through which all task 64 assigned to a particular administrator 52, team leader 54 or team member 66 or combination thereof are displayed. To reach this web page 230, the administrator 52 or team leader 54 or team member 66 opens the my tasks hyperlink 108 from any available web page. The filtering system 232 allows tasks to be displayed by status 234 (open, closed or both) and for a particular project party 236. After manually entering the status 234 and party criteria 36, the particular administrator 52, team leader 54 or team member 66 clicks the update icon 237, wherein a task listing report 238 is generated detailing all of the tasks 64. The task listing report 238 generates information regarding the particular task 64, workflow 62 and project 60, as well as information regarding the timing of the particular task, priority of the task, and status of the task.

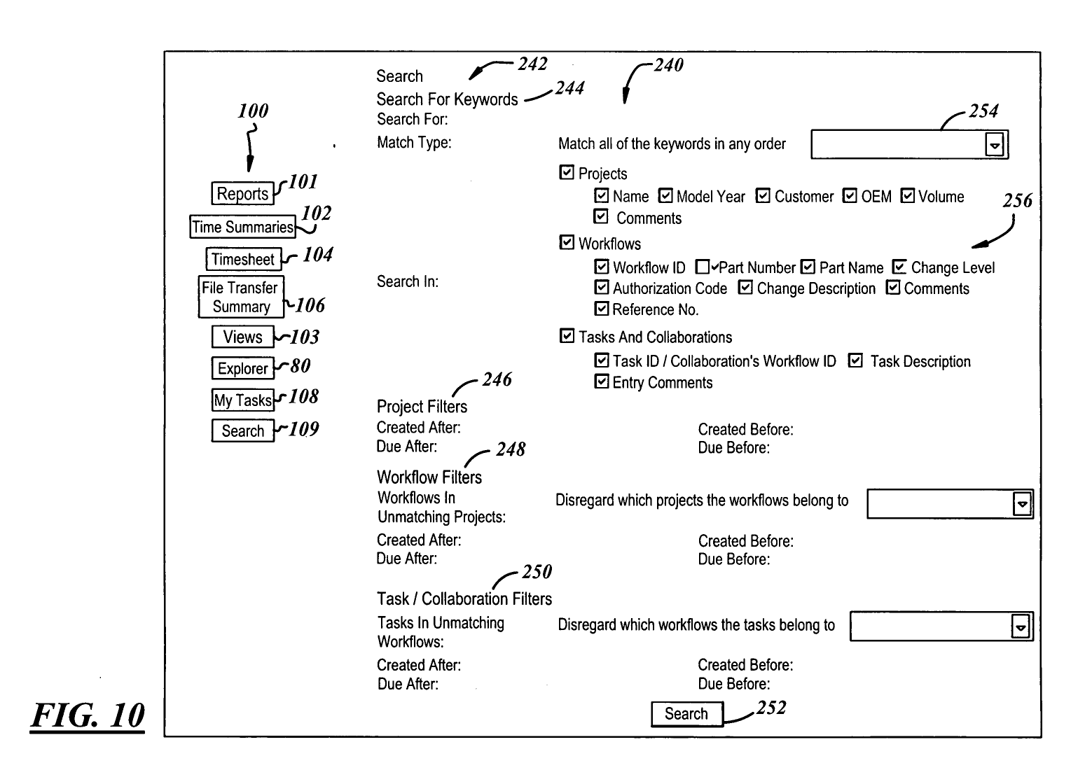

Referring now to FIG. 10, the search web page 240 includes a filtering system 242 through which a particular administrator 52, team leader 54 or team member 66 can search projects 60, workflows 62, or tasks 64 may be searched based on any number of different criteria. To reach this web page 240, the administrator 52 or team leader 54 or team member 66 opens the search hyperlink 109 from any available web page. To search for a particular project, task or workflow, the administrator 52 or team leader 54 or team member 66 simply enters the criteria desired in the search for keywords section 244, the project filters section 246, the workflow filters section 248, and/or the task collaborations filters section 250 and clicks the search icon 252. Whatever criteria match the search terms is then displayed for viewing.

In the search for keywords section, 244, the administrator 52 or team leader 54 or team member 66 enters a keyword in a keyword display area and clicks the particular files 256 to which he or she thinks the keyword may be found.

In the project filters section 246, the administrator 52 or team leader 54 or team member 66 may narrow the search to a particular project for a particular time period by manually entering a time range in the project filter.

In the workflow filters section 248, the administrator 52 or team leader 54 or team member 66 may narrow the search to a particular workflow or workflows for a particular time period by manually entering a time range in the workflow filter and further narrow the range to disregard the workflow in a particular project.

In the task/collaborations filter section 250, the administrator 52 or team leader 54 or team member 66 may narrow the search to a particular task or collaborative task for a particular time period by manually entering a time range in the task/collaborations filter and further narrow the range by disregarding workflows to a particular project.

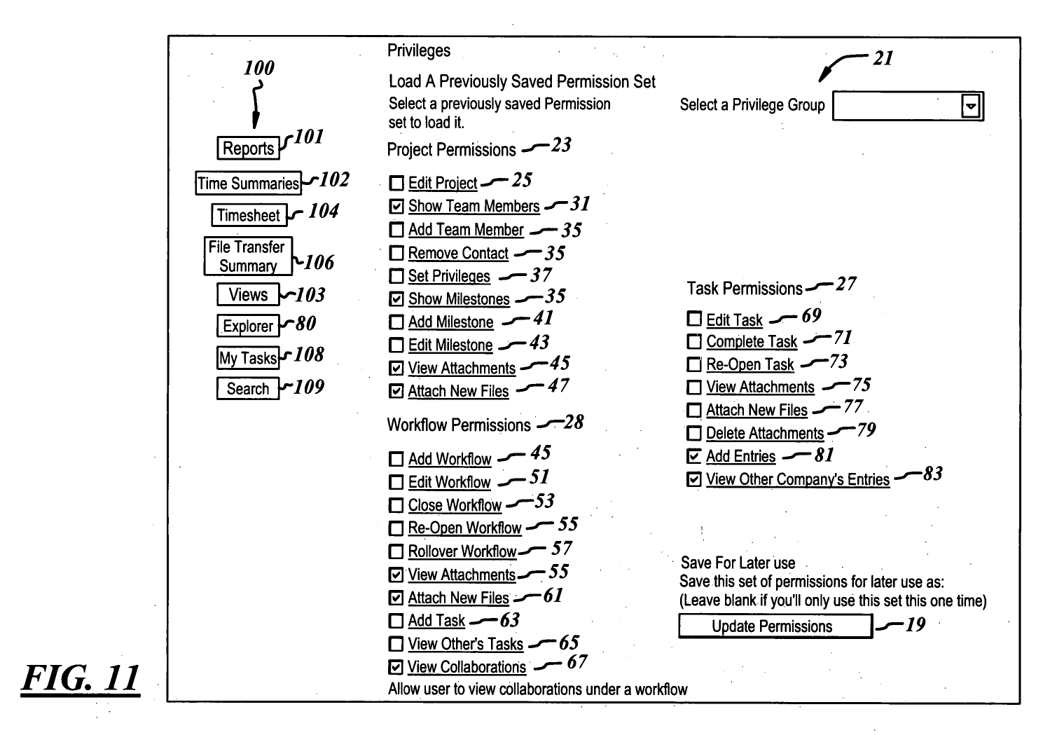

FIG. 11 illustrates the method by which an administrator 52 or team leader 54 enters privileges onto a privileges web page 21 for individuals designated by the parties 30 as team members 66 for a particular projects 60, workflows 62 or tasks 64. The administrator 52 or team leader 54 first enters the explorer web page 80 as described above. The administrator 52 or team leader 54 then clicks on a particular project link 60 and is directed to the projects web page 112 for a particular project 150. The administrator 52 or team leader 54 then clicks on the set privileges link associated with a particular project team member 154, which directs the administrator 52 or team leader 54 to the privileges web page 21.

The privileges web page 21 is displayed having three major categories, namely the project permission category 23, the workflow permissions category 25, and the task permissions category 27, each having its own group of subcategories described in detail below. The administrator 52 or team leader 54 then designates permissions granted to the team member 66 from the project permission category 23, the workflow permissions category 25, and/or the task permissions category 27. After completing the desired permissions grant, the administrator 52 or team leader 54 clicks the update permissions icon 19.

Under project permissions 23, the administrator 52 or team leader 54 grants to team members 66 permission to edit a project 29, show team members 31, add team members 33, remove contact information 35, set privileges for other project team members 37, show milestones 39 (allows the team members 66 to view milestones), add milestones 41, edit milestones 43, view attachments 45, and/or attach new files 47.

Under workflow permissions 25, the administrator 52 or team leader 54 grants to team members 66 permission to add workflows 49 for a particular project 150, edit workflows.51, close workflows 53, reopen workflows 55, rollover workflows 57, view attachment 59, attach new files 61, add task 63 related to the particular workflow 182, view other's tasks 65, and/or view collaborations 67 for a particular workflow 182.

Under task permissions 27, the administrator 52 or team leader 54 grants team members 66 permission to edit tasks 69, complete tasks 71, reopen tasks 73 that have previously been completed, view attachments 75, attach new files 77, delete attachments 79, add entries 81 such as logging hours or comments to a task or collaboration, and/or view other company's entries 83.

The present invention therefore provides a web based project management tool that allows parties 30 to seamlessly connect with one another, regardless of location and size, to share project information, track project progress and exchange data as needed in a secure environment. Parties 30 are not required to install and maintain or otherwise utilize heavy software downloads, but are offered a means to establish direct connectivity with each other and others as needed to manage any and all electronically based projects. The project management tool is equally useful for small sized entities and large sized entities. Moreover, because the access to the secure web site is limited by the parties themselves to administrators, team leaders and team members through a permission based access system, concerns about protection of company assets, privacy and other intellectual property are minimized.

While the invention has been described in connection with one embodiment, it will be understood that the invention is not limited to that embodiment. On the contrary, the invention covers all alternatives, modifications, and equivalents as may be included within the spirit and scope of the appended claims.

What is claimed is:

1. A method by which a party or parties can view, track, manage, and release informational data related to a specific collaborative programs, the parties selected from the group consisting of customers, vendors, suppliers, assemblers, manufacturers, and guest users, the method comprising:
providing a host entity having a central data management system, said central data management system including an accessible website;
uploading and storing one or more files from said party or parties on said accessible website within said central data management system, said one or more files having the informational data related to the specific program;
determining at least one project associated with the program;
determining at least one workflow associated with the specific project;
determining at least one task associated with said at least one workflow;
assigning at least one of said at least one team members to said at least one project, said at least one workflow, or said at least one task;
granting at least one team member of one of the party or parties permission-based access to said one or more files comprising said at least project, said at least one workflow, or said at least one task; and
allowing said at least one team member to access said website to view, track, manage, or release informational data related to said one or more files in accordance with said at least one team member's permission-based access.

2. The method of claim 1, wherein said at least one team member is granted permission-based access to view one or more files comprising said at least one project, said at least one workflow, or said at least one task.

3. The method of claim 1, wherein said at least one team member is granted permission-based access to view and manage one or more files comprising said at least one project, said at least one workflow, or said at least one task.

4. The method of claim 3, wherein said at least one team member is also granted permission-based access to upload or download one or more additional files to said website relating to said at least one project, said at least one workflow, or said at least one task.

5. The method of claim 3, wherein said at least one team member is also granted permission-based access to remove one or more files from said website.

6. The method of claim 1 further granting at least one team member of one of the party or parties permission-based access to said one or more files comprising two or more of said at least one project, said at least one workflow, and said at least one task.

7. The method of claim 1 further granting at least one team member of one of the party or parties permission-based access to said one or more files comprising said at least one project, said at least one workflow, and said at least one task.

8. The method of claim 1, wherein the step of granting at least one team member of one of the party or parties permission-based access comprises:
designating an administrator or a team leader from one of said parties or parties with access to a privileges web page located on said accessible website;
said administrator or said team leader determining one or more team members to assign to said at least one project, said at least one workflow, or said at least one task;
said administrator or said team leader also determining a set of permission-based privileges for each of said one or more team members relating to said one or more files comprising said at least one project, said at least one workflow, or said at least one task, said set of preferences selected from the group consisting of; and
said administrator or said team leader entering said privileges web page and granting said set of privileges for each of said assigned team members.

9. The method of claim 8 further comprising:
determining an administrator or a team leader from one of said parties or parties to have access to a privileges web page located on said accessible website, wherein said host entity therein assigns said administrator or said team leader with a privilege based access to enter said privileges web page.

10. The method of claim 1 further comprising creating a separately linked project web page for each of said at least one projects.

11. The method of claim 1 further comprising creating a separately linked web page related to each of said at least one projects.

12. The method of claim 1, further comprising creating a separately linked web page related to each of said at least one workflow; and
creating a separately linked web page related to each of said at least one tasks.

13. The method of claim 1, wherein said at least one of said at least one team members is notified via email confirming the assignment to said at least one project, said at least one workflow, or said at least one task.

14. The method of claim 1 further comprising providing a separately linked web page to a reports category, said reports category web page including web pages selected from the group consisting of a time summaries web page, a timesheet report web page, and a file summaries report web page, each of said reports category web pages related to said at least one project, said at least one workflow, and said at least one task.

15. The method of claim 1 further comprising providing a separately linked web page to a view category, said view category including web pages selected from the group consisting of an explorer web page, a my task web page, and a search web page, each of said view category web pages related to said at least one project, said at least one workflow, and said at least one task.

16. The method of claim 8, wherein said set of permission-based privileges is selected from the group consisting of project permissions, workflow permissions, and task permission.

17. The method of claim 16, wherein said project permissions are selected from the group consisting of editing a project, showing team members, adding team members, removing contact information, setting privileges for other project team members, showing milestones, adding milestones, editing milestones, viewing attachments, and attaching new files.

18. The method of claim 16, wherein said workflow permissions are selected from the group consisting of adding workflows for said project, editing workflows, closing workflows, reopening workflows, rolling over workflows, viewing attachments, attaching new files, adding tasks related to said workflow, viewing other's tasks, and viewing collaborations for said workflow.

19. The method of claim 16, wherein said task permissions are selected from the group consisting of editing tasks, completing tasks, reopening tasks, viewing attachments, attaching new files, deleting attachments, adding entries and viewing other company's entries.

20. An on-line project tracking system according to the method of claim 1.
